(19) United States
(12) Patent Application Publication
(10) Pub. No.: US 2012/0132489 A1
(43) Pub. Date: May 31, 2012

(54) Motor Vehicle Having A Retarder

(76) Inventors: Werner Adams, Crailsheim (DE); Hans-Martin Kulhanek, Crailsheim (DE); Bruno Fochi, Frankenhardt (DE); Alfred Weigel, Stimpfach (DE); Horst Pomereinke, Crailsheim (DE); Christa Pomereinke, Crailsheim (DE); Otto Laux, Fichtenau (DE); Herbert Doerr, Frankenhardt (DE); Andreas Brueckner, Windsbach (DE); Steffen Reinmuth, Spechbach (DE)

(21) Appl. No.: 13/318,472

(22) PCT Filed: May 27, 2010
(86) PCT No.: PCT/EP2010/003220

§ 371 Date: Jan. 6, 2012

(30) Foreign Application Priority Data
May 27, 2009 (DE) 10 2009 022 872.1

(51) Int. Cl. B60T 1/087; B60T 10/02

(52) U.S. Cl. 188/155; 188/159

(57) ABSTRACT

The invention relates to a motor vehicle

with a drive engine and transmission connected downstream in the power flow, wherein

the transmission comprises a transmission output shaft on the output side, via which drive power of the drive engine is transferred indirectly onto the drive wheels of the motor vehicle;

with a universal shaft which is connected directly or indirectly to the transmission output shaft in order to transfer drive power from the transmission output shaft via an axle gear or the like onto the drive wheels;

with a vehicle frame, on which the drive engine, the transmission, the universal shaft and the drive wheels are suspended or mounted at least indirectly;

with a hydrodynamic retarder, electromagnetic retarder or permanent magnet retarder, comprising a rotor and a stator, which are switchable via a hydrodynamic working medium circuit or a magnetic field into a torque-transferring connection, so that the rotor is braked by torque transfer to the stator, with the rotor being in a drive connection with the drive wheels in order to brake same, wherein
the rotor is mounted on the universal shaft on the outside and is supported by the same.

The motor vehicle according to the invention is characterized in that the stator is relatively supported by means of a retarder bearing, and is supported by the rotor and is supported against rotating by means of a torque support at least indirectly on the vehicle frame.

The present invention relates to a motor vehicle with a retarder, in detail according to the preamble of claim 1.

Retarders are used in motor vehicles for wear-free braking of the vehicle. One distinguishes between different types of retarders such as hydrodynamic retarders, electromagnetic retarders, which are also known as electrodynamic retarders or eddy-current brakes, and permanent magnet retarders. The present invention relates to any kind of retarders, but it is especially suitable for use with a permanent magnet retarder.

Hydrodynamic retarders comprise a rotor and the stator which jointly form a working chamber which can be filled or is filled with a working medium. A torque-transferring working medium circulation is formed in the working chamber by drive of the rotor, by means of which torque is transferred from the rotor to the stator, leading to braking of the revolving rotor since the stator is held in a stationary manner. The level of the braking torque can be set for example by changing the degree of filling of the working chamber.

In the case of electromagnetic retarders (eddy-current brakes), a magnetic field is generated by means of electromagnets in which a rotor made of a magnetizable material revolves. By applying the magnetic field to the rotor it is braked. It is principally also possible to provide the electromagnets in the retarder and the magnetizable material in the stator.

In the case of the permanent magnet retarder, permanent magnets are arranged in the stator which optionally generate a magnetic field in which the rotor rotates which is made of a magnetizable material. The position of the permanent magnets and/or a component associated with the same, e.g. a pole shoe, is variable in such a way that in a first state no magnetic force acts on the rotor and the maximum magnetic force acts on the rotor in a second state. For example, the magnets can be bridged in the deactivated state in such a way that no magnetic force will flow to the rotor, and the bridging is lifted in the activated state. It is also possible to provide states with reduced magnetic force for setting a variable braking torque.

Although the known kinds of retarders offer numerous advantages due to their ability to brake the vehicle in a wear-free manner, the integration in the vehicle always requires an additional constructional effort, especially by additionally provided rolling bearings or sliding bearings which carry the retarder in a rotatable manner. This is especially the case when the retarder is to be arranged in the region of the universal shaft of a vehicle which connects the vehicle transmission with the drive wheels or an axle gear on the axle of the drive wheels, since in this case modifications need to be made to the universal shaft. Usually, the universal shaft will be shortened or interrupted, and the retarder will be connected with its own bearing to the shortened or the two interrupted parts of the universal shaft. The bearing of the retarder frequently also needs to absorb bending forces in addition to axial and radial forces, and therefore mostly consists of two bearings that are axially spaced.

It is understandable that this kind of bearing is expensive and heavy.

Document U.S. Pat. No. 3,871,466 A describes an electromagnetic retarder, the stator of which, in combination with the electromagnets, is suspended on the vehicle frame of a vehicle and which carries a connecting shaft via a rolling bearing, which connecting shaft connects on the one hand two cardan shafts on the output side of the transmission with each other, and on the other hand carries the rotor of the retarder which encloses the stator with the electromagnets in the axial direction on both sides. It is disadvantageous in this embodiment that the installation of such a retarder in an existing drive train requires a plurality of universal shafts on the output side of the transmission, which is constructionally complex and expensive on the one hand and can lead to problems in respect of torsional vibrations and unbalances on the other hand. The known angle error of cardan shafts is especially serious, which is added up by the plurality of cardan shafts.

The present invention is based on the object of providing a motor vehicle with a retarder which is characterized by cost-effective integration of the retarder in the region of the universal shaft in combination with reliable bearing of the components present in the drive train.

The object in accordance with the invention is achieved by a motor vehicle with the features of claim 1. Advantageous and especially appropriate embodiments of the invention are provided in the dependent claims.

The motor vehicle in accordance with the invention comprises a drive engine and a transmission which is provided downstream in the power flow. The transmission transfers the drive power of the drive engine with selectable gear ratios to the drive wheels of the vehicle, usually via an axle gear, differential gear or the like, as is known.

A universal shaft is provided between the transmission and the drive wheels in the drive train of the motor vehicle, which universal shaft transfers drive power from a transmission output shaft on the side of the power take-off to the drive wheels, usually via an axle gear on the drive axle of the drive wheels. The universal shaft can be connected directly or indirectly to the transmission output shaft.

The vehicle further comprises a vehicle frame which provides the vehicle with stability and on which the drive engine, the transmission, the universal shaft and the drive wheels are suspended or mounted at least indirectly. Usually, further components are carried by the vehicle frame such as the car body and the like for example.

The vehicle is equipped with a retarder that can have the configuration of a hydrodynamic retarder, electromagnetic retarder (eddy-current brake) or permanent magnet retarder, as has been explained above. The retarder comprises at least one rotor and a stator which, as has been explained above, are switchable via a hydrodynamic working medium circuit or a magnetic field into a torque-transferring connection, so that the rotor is braked on the stator by this torque transfer. The rotor is in a drive connection with the drive wheels of the vehicle and can brake the same in this way when the retarder is activated.

In accordance with the invention, the rotor of the retarder is mounted on the outside on the universal shaft and is supported by the universal shaft. This means that no additional bearing is required for carrying the retarder rotor, which would not have been provided in the vehicle anyway for bearing the universal shaft if the vehicle would have been equipped without the retarder. It is therefore possible to omit a separate bearing for the rotor of the retarder.

The feature in accordance with the invention in that the rotor is supported by the universal shaft means that forces acting on the rotor in the axial direction and/or the radial direction or circumferential direction are absorbed by the universal shaft, especially exclusively by the universal shaft. These forces are therefore not discharged via an additional bearing.

The stator is held in a relative way by means of a retarder bearing on the rotor and is supported by the rotor. In order to prevent revolving of the stator with the rotor, the stator rests via a torque support at least indirectly on the vehicle frame against twisting. Apart from this support by means of the torque support, the stator can advantageously be free from a force-transferring linkage and/or bearing on the vehicle frame and be supported exclusively by the rotor. As a result, only measures are necessary which enable mounting of the rotor on the universal shaft without requiring any further bearing for the stator on the vehicle frame.

In an especially advantageous way, the rotor of the retarder is rigidly connected to the universal shaft in the axial direction and the radial direction, e.g. it is screwed or pressed onto the same. Principally, an integral arrangement of the rotor with the universal shaft is possible, but this would require a modification of the universal shaft in respect of vehicles without a retarder.

The rotor of the retarder is arranged according to one embodiment at a predetermined distance from the two axial ends of the universal shaft, e.g. in the region of the axial center of the universal shaft. The region of the axial center not only comprises the precise axial center, but also a respective region before and behind the axial center, e.g. the middle third of the universal shaft. It is understood that other regional limitations are possible. It is also possible to arrange the retarder or its rotor at another position of the universal shaft, e.g. at one axial end or in the region of an axial end.

The retarder bearing, by means of which the stator is held in a relative way on the rotor, is advantageously arranged as a rolling bearing, e.g. a deep groove ball bearing, and is especially arranged directly between the rotor and the stator.

Relatively long universal shafts, especially in commercial vehicles such as a truck or a rail vehicle, is mounted via a so-called intermediate bearing in its axially middle region on the vehicle frame. The retarder which is integrated in accordance with the invention can now be positioned in the region of this intermediate bearing.

The intermediate bearing can advantageously be connected via an elastic element, especially an elastomeric or rubber element, to the vehicle frame.

The intermediate bearing is usually carried by a crossbeam of the vehicle frame which connects two longitudinal beams of the vehicle frame with reference to the longitudinal axis of the vehicle.

Although such an intermediate bearing apparently only offers very limited possibilities at first to absorb bending forces as can occur by the rotation of the retarder rotor, an exceptionally rigid overall bearing is obtained in combination with a respectively rigid bearing of the transmission output shaft in the vehicle transmission by the lever arm of the universal shaft between the transmission output shaft and the rotor.

The universal shaft between the transmission output shaft and the rotor of the retarder can advantageously be free from any length compensation, e.g. a sliding element between the transmission and intermediate bearing. In the case of an elastic suspension of the intermediate bearing it is further possible to arrange the stiffness of the suspension in the radial direction so that it deviates from the stiffness in the axial direction relating to the universal shaft. Especially advantageously, a comparatively lower stiffness is set in the axial direction and a higher stiffness in the radial direction.

According to one embodiment, the universal shaft comprises at least two joints, and in another embodiment also three or more joints. The joint can be arranged as universal joints for example. It is possible by means of such a universal shaft to position the transmission in another, especially horizontal, plane than the drive shaft or the axle gear of the drive shaft for the drive wheels.

In accordance with one advantageous embodiment, the universal shaft is arranged as a cardan shaft with a cardan shaft flange which carries a journal cross. The cardan shaft flange comprises one or several receivers protruding in the radial direction which can be forged onto the cardan shaft flange for example. For example, a single receiver can be provided which protrudes radially circumferentially in the circumferential direction or, according to another advantageous embodiment, two receivers which are opposite of one another over the circumference. The rotor can now be mounted on the receiver or the receivers, and especially can be screwed onto the same.

In accordance with an advantageous embodiment, the rotor encloses the stator in the circumferential direction radially from the outside. Additionally or alternatively, the rotor can comprise an inner support ring which extends radially within the stator and on which the stator is relatively supported by means of the retarder bearing, especially by means of the rolling bearing arranged between the support ring and the stator. In this case, the support ring can enclose the universal shaft, especially a cylindrical axial section of the same, with play or at a distance, with an especially small distance being designated as play in this case.

When the retarder is arranged as a permanent magnet retarder, its stator advantageously carries a plurality of permanent magnets which are arranged one after the other in the circumferential direction over the rotational axis with alternating polarity, and the rotor comprises at least one or several regions made of magnetizable material which face the permanent magnets. It is further advantageous to provide a switching element between the permanent magnets and the at least one region made of a magnetizable material, with the switching element extending in a disk-like, annular or ring-segment-like manner in the circumferential direction over the rotational axis of the rotor and between the rotor and the stator in such a way that magnetizable return-path elements of the switching element alternate with non-magnetizable intermediate elements of switching element in the circumferential direction. Furthermore, at least one actuator is provided in this case, by means of which the permanent magnets are mutually twistable with respect to the switching element and/or the switching element with respect to the permanent magnets in the circumferential direction in an alternating fashion in order to place the return-path elements opposite of the permanent magnets in a first position and the intermediate elements opposite of the permanent magnets in a second position. The permanent magnet retarder can be switched on and off in this way in that whenever the return-path elements are opposite of the permanent magnets in the first position a magnetic field is obtained from the stator via the return-path elements to the rotor and back to the stator, so that the rotor is braked. If on the other hand the intermediate elements are opposite of the permanent magnets in the second position, the return-path elements will short-circuit two permanent magnets which have mutual polarity and are arranged adjacent to one another in the circumferential direction, so that only a “small” magnetic circuit or circular magnetic field is obtained between the permanent magnets and the return-path elements, which field does not reach beyond the system boundary between rotor and stator and thus does not flow both through the rotor and the stator. Accordingly, the rotor can revolve freely or substantially without braking through a magnetic field opposite of the stator. The permanent magnet retarder is switched off.

The invention will be explained below by way of examples by reference to embodiments and the drawings, wherein:

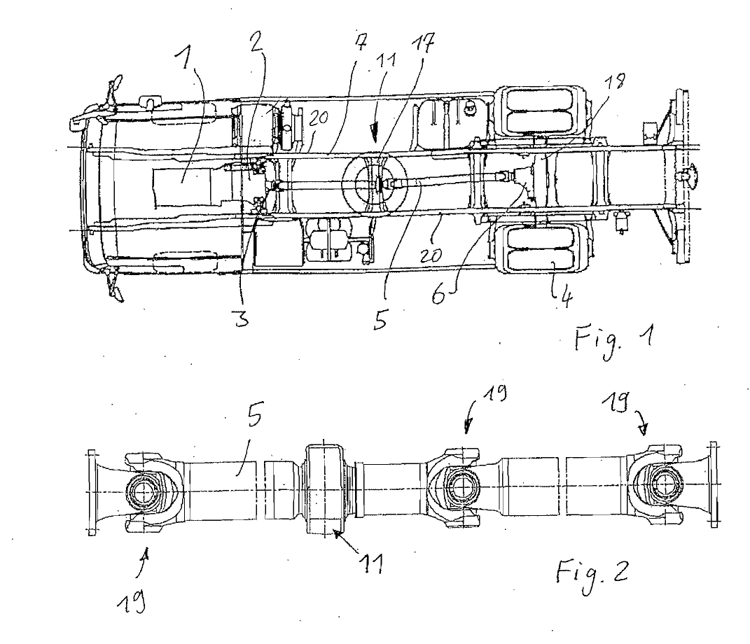

FIG. 1 shows a schematic top view of a vehicle with illustration of the positioning of the universal shaft in the drive train of the vehicle;

FIG. 2 shows an enlarged view of the universal shaft of FIG. 1;

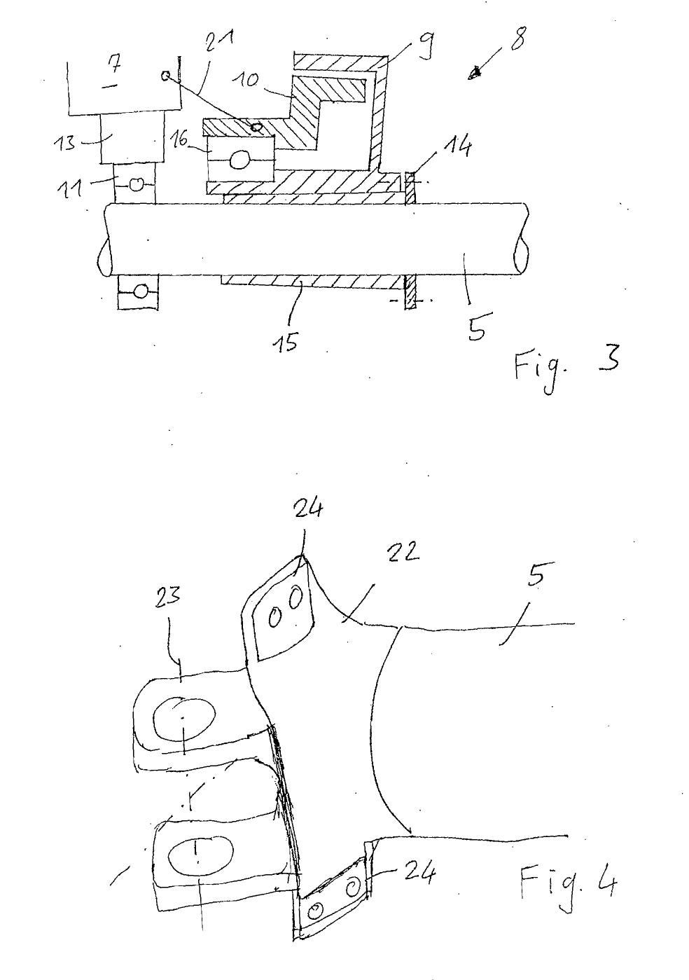

FIG. 3 shows a first embodiment of the arrangement in accordance with the invention of a permanent magnet retarder on the universal shaft;

FIG. 4 shows an alternative connection possibility for the rotor on the cardan shaft flange by ear-shaped receivers which are forged onto the flange;

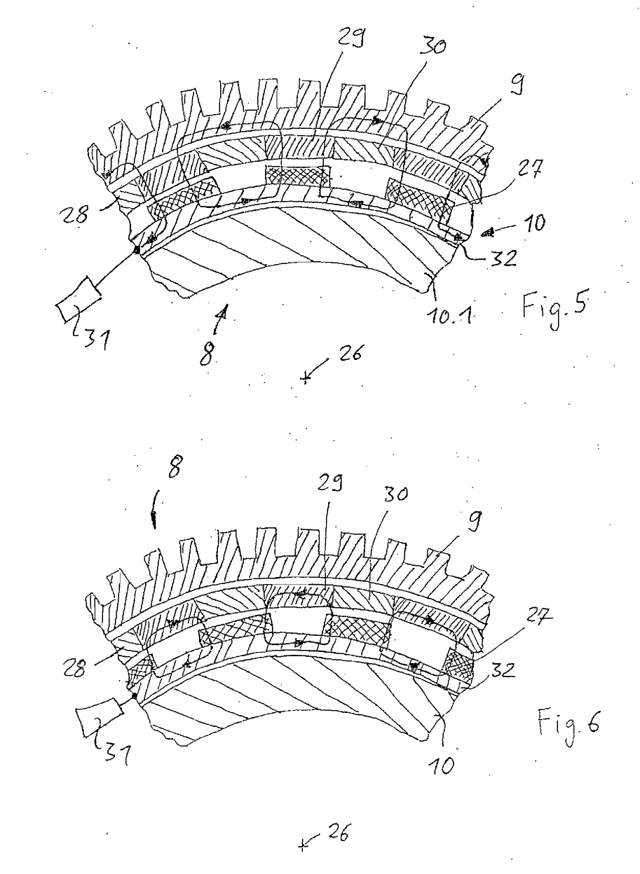

FIG. 5 shows a schematic view of an embodiment with a permanent magnet retarder in the activated state;

FIG. 6 shows the embodiment of FIG. 5 in the deactivated state;

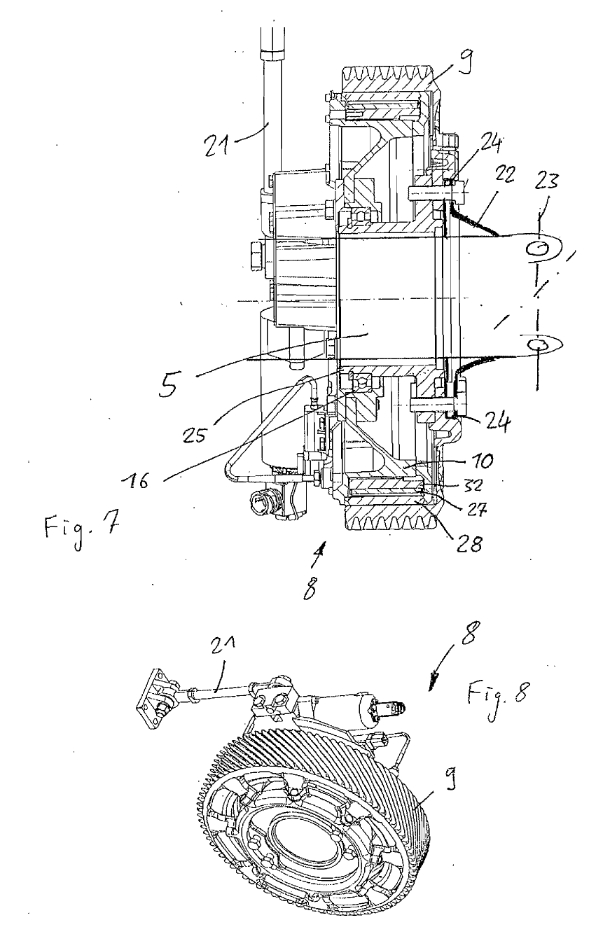

FIG. 7 shows an axial sectional view through a permanent magnet retarder according to FIGS. 5 and 6;

FIG. 8 shows a three-dimensional view of the permanent magnet retarder of FIG. 7.

FIG. 1 shows a schematic top view of a vehicle with a drive engine 1, a transmission 2 and drive wheels 4. The drive wheels are driven by way of a drive axle 18, which on its part is associated with an axle gear 6, e.g. a differential gear. A universal shaft 5 is provided in order to transfer drive power of the drive engine 1 from the transmission 2 to the axle gear 6, with the axle gear 6 being arranged in a different plane than the transmission 2, which universal shaft connects the transmission output shaft 3 with the axle gear 6. The universal shaft 5 is held at its first axial end on the drive side in the transmission 2 via the transmission output shaft 3, and at its second axial end on the output side via an input shaft of the axle gear 6 on the axle gear 6 and/or via the same on the drive axle 18.

Furthermore, the universal shaft 5 is suspended in the region of the axial center of the universal shaft 5 via an intermediate bearing 11 on the vehicle frame 7, more precisely on a crossbeam 17 of the same which connects two longitudinal beams 20, before the second of three joints of the universal shaft 5 in the direction of the drive power flow from the engine 1 to the drive wheels 4, as seen in this case.

FIG. 2 shows the entire universal shaft 5 again with the intermediate bearing 11 and the three joints 19 which are arranged thereon.

FIG. 3 shows an embodiment of a retarder which is mounted completely on the universal shaft 5, which retarder is arranged in this case too as a permanent magnet retarder 8, as shown in the region of the intermediate bearing 11. For this purpose, the rotor 9 is supported in a torsion-proof manner by the universal shaft 5, and the stator 10 is relatively supported on the rotor 9, which occurs by means of the retarder bearing 16 radially between the rotor 9 and stator 10.

The relative bearing by means of the retarder bearing 16 leads to a radial and/or axial support of stator 10 on the rotor 9 or the universal shaft 5, in combination with a relative twistability in relation to the universal shaft 5 or the rotor 9. In order to prevent the stator 10 from revolving with the rotor 9 or the universal shaft 5, a torque support 21 is further provided on the stator 10, by means of which stator 10 rests on the vehicle frame 7 or on a component connected to the latter.

In FIG. 3 too, the universal shaft 5 is suspended by means of an intermediate bearing 11 in the region of its axial center on the vehicle frame 7, with or without an elastic elements 13, as required. As a result, it is only necessary to provide a single additional bearing between the rotor 9 and the stator 10 or between the universal shaft 5 and the stator 10 for the integration of the retarder in vehicle, and all forces acting on the rotor 9 are discharged directly to the universal shaft 5. These forces acting on the stator 10 are also discharged via the retarder bearing 16 onto the universal shaft 5, with the exception of the forces in the circumferential direction which are discharged via the torque support 21 onto the vehicle frame 7.

In the embodiment as shown in FIG. 3, the rotor 9 is mounted on the universal shaft 5 in a positive or non-positive way by means of a sleeve slid onto the universal shaft 5, which sleeve is arranged in this case as a clamping sleeve 15. It is obvious that in this embodiment it is possible to choose other possibilities for mounting the rotor 9 on the universal shaft 5, e.g. the schematically indicated flange 14 of the universal shaft 5, on which the rotor 9 can be screwed or mounted in another way.

FIG. 4 shows the cardan shaft flange 22 of the universal shaft 5 which carries a journal cross 23 (only indicated schematically). Two receivers 24 are provided directly on the cardan shaft flange 22, which are advantageously arranged integrally with the same, e.g. by forging, onto which the rotor of the retarder can be screwed. This embodiment has proven to be especially advantageous because oscillations can be avoided to a substantial extent by the chosen positioning of the receivers 24 directly on the cardan shaft flange 22. It was even possible to dampen torsional oscillations of the universal shaft.

In the case of an embodiment of a permanent magnet retarder as shown in FIGS. 5 and 6 whose rotor 9 and stator 10 can be supported by the universal shaft in accordance with the invention, the rotor 9 encloses the stator 10 in the circumferential direction. The rotor 9 rotates via the rotational axis 26 and is arranged concentrically to the stator 10.

Stator 10 comprises an annular magnet carrier 32 which is displaceable in the circumferential direction relative to a radially inner fixed core region 10.1 and which carries a plurality of permanent magnets 27. The permanent magnets 27 are arranged in the circumferential direction over the rotational axis 26 with alternating polarity behind one another, which means all permanent magnets 27 in the sequence with even position numbers have a radially outer north pole and a radially inner south pole, and all permanent magnets with an odd position number have a radially outer south pole and a radially inner north pole.

A switching element 28 is arranged in the radial direction between the rotor 9 and the stator 10, which switching element can especially be arranged in a stationary manner, e.g. as a housing shell of the stator 10. The switching element 28 has an annular shape and magnetizable return-path elements 29 alternate in the circumferential direction with non-magnetizable intermediate elements 30. The return-path elements 29 are made of steel or iron for example and the non-magnetizable intermediate elements are made of aluminum.

When the return-path elements 29 are opposite of the permanent magnets 27 in the radial direction as shown in FIG. 5, and are especially in alignment with each other, a magnetic field can be formed which reaches from the stator 10 to the rotor 9 and back again. As is shown, the outer magnetic flux lines of the magnetic field reach from a first permanent magnet 27 through the opposite return-path element 29 into the rotor 9, which is especially made of iron or steel, in the circumferential direction along rotor 9, back through a second return-path element 29 radially to the inside through a second permanent magnet 27, and back in the opposite circumferential direction as in rotor 9 through the magnet carrier 32, which can also be made of steel or iron, into the first permanent magnet 27 again. If on the other hand, as shown in FIG. 6, the intermediate elements 30 are opposite of the permanent magnets 27 in the radial direction, one return-path element 29 each bridges two adjacently arranged permanent magnets 27, so that a smaller magnetic field is achieved which does not reach up into the rotor 9.

The stator 10 therefore exerts a braking effect on the rotor 9 by means of the magnetic field at the position in FIG. 5 which will be designated in this case as first position, whereas in the position which in this case is designated as the second position according to FIG. 6 no braking moment is exerted by a magnetic field on rotor 9. The permanent magnet retarder 8 is switched on in the first position and switched off in the second position.

An actuator 31 is connected to the magnet carrier 32 for delimited displacement of the same, which actuator is formed by a single-acting or double-acting pressure cylinder, or several thereof. Other forms of actuators are also possible such as electric, pneumatic or hydraulic.

FIG. 7 shows again how a permanent magnet retarder 8 according to FIGS. 5 and 6 can be connected to a cardan shaft flange 22 according to FIG. 4. The receivers 24 are shown, onto which the rotor 9 is screwed.

In the illustrated embodiment, the rotor 9 comprises an inner support ring 25 which extends radially within the stator 10 and on which the stator 10 is relatively supported by means of the retarder bearing 16.

The inner support ring 25 encloses the universal shaft 5, which in this case is a cylindrical part of the same and which is adjacent to the cardan shaft flange 22 in the direction of the permanent magnet retarder 8 at a predetermined distance. According to the embodiment as shown in FIGS. 5 and 6, the rotor 9 encloses the stator 10 radially from the outside. The stator 10 on the other hand comprises the magnet carrier 32 with the permanent magnets 27 and switching element 28 between the rotor 9 and the permanent magnets 27.

FIG. 7 further shows the torque support 21, by means of which the stator 10 is supported on the vehicle frame.

FIG. 7 finally shows the journal cross 23 in a schematic view.

The embodiment of FIG. 7 is shown again in a three-dimensional oblique top view in FIG. 8.

1.-12. (canceled)

13. A motor vehicle comprising:
a drive motor and a transmission connected downstream thereof in the power flow, wherein the transmission includes a transmission output shaft on the power take-off side, via which drive power of the drive motor is transmitted indirectly to the drive wheels of the motor vehicle;
a cardan shaft, which is connected directly or indirectly to the transmission output shaft, in order to transmit the drive power from the transmission output shaft (3) to the drive wheels via an axle drive or similar;
a vehicle frame, on which the drive motor, the transmission, the cardan shaft and the drive wheels are suspended or mounted at least indirectly;
a hydrodynamic retarder, an electromagnetic retarder or a permanent magnetic retarder, including a rotor and a stator, which can be engaged via a hydrodynamic working fluid circuit or a magnetic field in a torque-transmitting connection, so that the rotor is braked down by the transmission of the torque on the stator, wherein the rotor provides a drive connection with the drive wheels, so as to slow them down, wherein the rotor is mounted externally on the cardan shaft and is carried by said shaft;
characterised in that:
the stator is relatively supported by a retarder bearing on the rotor and is carried by the rotor and is protected against twisting via a torque support at least indirectly on the vehicle frame.

14. The motor vehicle according to claim 13, characterised in that the rotor is connected fixedly to the cardan shaft in axial direction and radial direction.

15. The motor vehicle according to claim 13, characterised in that the rotor is mounted on the cardan shaft with a predetermined distance with respect to both axial ends of the cardan shaft, in particular in the region of the axial centre or of a central third of the cardan shaft, or the rotor is mounted on an axial end of the cardan shaft.

16. The motor vehicle according to claim 14, characterised in that the rotor is mounted on the cardan shaft with a predetermined distance with respect to both axial ends of the cardan shaft, in particular in the region of the axial centre or of a central third of the cardan shaft, or the rotor is mounted on an axial end of the cardan shaft.

17. The motor vehicle according to claim 13, characterised in that the cardan shaft is suspended on the vehicle frame, in particular elastically, via an intermediate bearing in the axial region between both its ends and at a distance therefrom, in particular in the region of their axial centre or of a central third, and the retarder is arranged in the area of the intermediate bearing.

18. The motor vehicle according to claim 14, characterised in that the cardan shaft is suspended on the vehicle frame, in particular elastically, via an intermediate bearing in the axial region between both its ends and at a distance therefrom, in particular in the region of their axial centre or of a central third, and the retarder is arranged in the area of the intermediate bearing.

19. The motor vehicle according to claim 15, characterised in that the cardan shaft is suspended on the vehicle frame, in particular elastically, via an intermediate bearing in the axial region between both its ends and at a distance therefrom, in particular in the region of their axial centre or of a central third, and the retarder is arranged in the area of the intermediate bearing.

20. The motor vehicle according to claim 16, characterised in that the cardan shaft is suspended on the vehicle frame, in particular elastically, via an intermediate bearing in the axial region between both its ends and at a distance therefrom, in particular in the region of their axial centre or of a central third, and the retarder is arranged in the area of the intermediate bearing.

21. The motor vehicle according to claim 13, characterised in that the cardan shaft is designed as a universal joint shaft, with a universal joint shaft flange, which carries a cross joint, and the universal joint shaft flange presents one or several seats protruding in radial direction which is/are forged on the universal joint shaft flange in particular, against which the rotor is assembled, in particular screwed on.

22. The motor vehicle according to claim 14, characterised in that the cardan shaft is designed as a universal joint shaft, with a universal joint shaft flange, which carries a cross joint, and the universal joint shaft flange presents one or several seats protruding in radial direction which is/are forged on the universal joint shaft flange in particular, against which the rotor is assembled, in particular screwed on.

23. The motor vehicle according to claim 15, characterised in that the cardan shaft is designed as a universal joint shaft, with a universal joint shaft flange, which carries a cross joint, and the universal joint shaft flange presents one or several seats protruding in radial direction which is/are forged on the universal joint shaft flange in particular, against which the rotor is assembled, in particular screwed on.

24. The motor vehicle according to claim 16, characterised in that the cardan shaft is designed as a universal joint shaft, with a universal joint shaft flange, which carries a cross joint, and the universal joint shaft flange presents one or several seats protruding in radial direction which is/are forged on the universal joint shaft flange in particular, against which the rotor is assembled, in particular screwed on.

25. The motor vehicle according to claim 13, characterised in that the rotor encloses the stator radially and outwardly along the periphery.

26. The motor vehicle according to claim 14, characterised in that the rotor encloses the stator radially and outwardly along the periphery.

27. The motor vehicle according to claim 13, characterised in that the rotor includes an inner supporting ring, which extends radially inside the stator and on which the stator is relatively mounted via the retarder bearing, in particular by means of an anti-friction bearing arranged between the supporting ring and the stator.

28. The motor vehicle according to claim 27, characterised in that the supporting ring encloses the cardan shaft, in particular a cylindrical region thereof, with a play or an distance.

29. The motor vehicle according to claim 13, characterised in that the retarder is designed as a permanent magnetic retarder, whose stator carries a plurality of permanent magnets arranged behind one another with alternating polarity along the periphery via the rotational axis and the rotor includes at least one or several regions, made of magnetisable material, facing the permanent magnets, moreover with a switching element between the permanent magnets and the at least one region made of magnetisable material, whereas the switching element extends in such a way in the form of a disc, of a ring or of an annular segment along the periphery via the rotational axis between the rotor and the stator, that magnetisable return elements alternate with not magnetisable intermediate elements of the switching element around the periphery, and with at least one actuator, by means of which the permanent magnets can be twisted with respect to the switching element and/or the switching element can be twisted with respect to the permanent magnets around the periphery, in order, in a first position, to oppose the return elements with respect to the permanent magnets and in a second position the intermediate elements with respect to the permanent magnets.

30. The motor vehicle according to claim 13, characterised in that the rotor is mounted on the cardan shaft via a sleeve, in particular a clamping sleeve slid on the cardan shaft.

31. The motor vehicle according to claim 13, characterised in that the rotor is mounted, in particular screwed on the cardan shaft, on a flange provided on the cardan shaft.

32. The motor vehicle according to claim 13, characterised in that the cardan shaft, which is designed in particular as a universal joint shaft with two or three joints, forms the single cardan shaft between the transmission and the axle drive or between the transmission and the drive wheels.
